(19) United States
(12) Patent Application Publication
(10) Pub. No.: US 2026/0139547 A1
(43) Pub. Date: May 21, 2026

(54) SHUTTER ASSEMBLY

(71) Applicant: Louver-Lite Limited, Cheshire (GB)

(72) Inventor: Andrew Greening, Cheshire (GB)

(73) Assignee: Louver-Lite Limited, Cheshire (GB)

(21) Appl. No.: 19/119,850

(22) PCT Filed: Oct. 10, 2023
(86) PCT No.: PCT/GB2023/052625

§ 371 Date: Apr. 10, 2025

(30) Foreign Application Priority Data
Oct. 10, 2022 (GB) 2214917.3

(51) Int. Cl. E06B 9/04

(52) U.S. Cl. CPC E06B 9/04

(57) ABSTRACT

A shutter assembly including a shutter-style window covering; and at least one mounting clip, wherein the shutter-style window covering includes an outer frame that defines an aperture; and at least one shutter door which includes a door frame and a plurality of vanes that are rotatably coupled to the door frame, wherein the vanes have a first orientation in which completely obscure an aperture defined by the door frame, and a second orientation in which they partially obscure the aperture; wherein the or each shutter door is hingedly coupled to the outer frame; wherein the outer frame defines at least one mounting clip receiving portion; wherein the or each mounting clip is detachably coupled to a respective one of the mounting clip receiving portion; and wherein the clip includes a window engagement portion via which the mounting clip may be detachably coupled to a window.

The present invention relates to shutter assemblies, in particular shutter assemblies for windows.

Shutter assemblies for windows are well known and have existed for decades. In a typical shutter assembly, a shutter frame is screwed to a window frame and a shutter door is hingedly coupled to the shutter frame. In such an arrangement, the hinge assembly is usually visible and there are gaps between the shutter door and the shutter frame, and sometimes also between the shutter frame and the window frame to which it is secured. Such shutter assemblies are relatively expensive to manufacture and difficult to install. Furthermore, if it is desired to remove a shutter door for any reason, e.g., maintenance or cleaning, either the hinge assembly need to be removed or the shutter frame must be unscrewed from the window frame.

WO2021/156515 describes an alternative shutter assembly which includes an outer frame, an inner frame and a hinged shutter door.

There is therefore a desire to provide a shutter assembly that has the looks of a conventional shutter assembly, but which is cheaper to manufacture and easier to install and maintain.

The present invention seeks to address one or more of the problems associated with known shutter assemblies.

According to a first aspect of the invention, there is provided a shutter assembly including a shutter-style window covering; and at least one mounting clip, wherein the shutter-style window covering includes an outer frame that defines an aperture; and at least one shutter door which includes a door frame and a plurality of vanes that are rotatably coupled to the door frame, wherein the vanes have a first orientation in which completely obscure an aperture defined by the door frame, and a second orientation in which they partially obscure the aperture; wherein the or each shutter door is hingedly coupled to the outer fame and is disposed within the aperture; wherein the outer frame defines at least one mounting clip receiving portion; wherein the or each mounting clip is detachably coupled to a respective one of the mounting clip receiving portion; and wherein the clip includes a window engagement portion via which the mounting clip may be detachably coupled to a window, for example to a window comprising a glazing panel and a bead.

The skilled person will understand that a window bead is conventionally disposed between a glazing panel and a window frame. In an embodiment of the invention, the window engagement portion may engage a window bead, for example, the window engagement portion may be disposed between the window bead and the glazing panel.

It will be appreciated that the shutter-style window covering outer frame is directly connected to a window and does not hinge or pivot relative to the window. Thus, the window covering outer frame is fixed relative to the window to which it is secured. Accordingly, the light transmission through the window may be controlled simply by rotating the vanes about their respective rotational axes. However, the shutter door may be hinged relative to the window covering outer frame (and therefore also relative to the window itself) to uncover the aperture defined by the outer frame.

If it is desired to access the window or to remove the shutter assembly for cleaning, the window covering outer frame can be detached from the or each mounting clip and then removed from the window.

Reference herein to the window covering outer frame defining one or more mounting clip receiving portions includes one or more mounting clip receiving portions directly defined by the outer frame and also an arrangement in which one or more insert elements form part of the outer frame and the or each insert element defines the mounting clip receiving portion. In such embodiments, the insert element(s) may be fixed to the outer frame or may be detachably coupled to the outer frame.

In an embodiment of the invention, the window covering outer frame comprises a top frame member, a bottom frame member and a pair of opposed side frame members. Thus, the frame defines a rectangular aperture therewithin. As most windows are rectangular, a rectangular outer frame is most appropriate.

In relation to the shutter door(s), the or each shutter door may comprise a top rail, a bottom rail and a pair of opposed stiles (i.e., side rails), wherein the top rail, bottom rail and opposed stiles define a rectangular door frame. The vanes are typically rotatably coupled to the opposed side rails or stiles. Thus, one end of a vane may be rotatably coupled to one of the stiles and the other end of the vane may be rotatably coupled to the other of the stiles. In such embodiments, each vane may define a substantially horizontal axis of rotation in use.

The vanes of the subject invention may be as described in PCT/GB2023/050559.

With shutter assemblies, it is often desired to rotate all of the vanes simultaneously. Accordingly, the vanes may be connected together via a connecting element such that rotation of one of the vanes results in a corresponding rotation of all of the vanes, or movement of the connecting element results in the rotation of all of the vanes together.

As noted herein, the window covering outer frame may be releasably coupled to a window via a detachable coupling between the or each mounting clip and the respective mounting clip receiving portions. The detachable coupling may be a friction fit provided between each mounting clip and the respective mounting clip receiving portion or it may be a snap fit provided between each mounting clip and the respective mounting clip receiving portion. For example, the mounting clip may include a locating lug which fits within a corresponding aperture defined by the mounting clip receiving portion. In the context of the subject invention, such an arrangement of a locating lug and a corresponding aperture is considered to be a snap fit arrangement.

In embodiments in which a snap fit coupling is provided between the or each mounting clip and the respective mounting clip receiving portion, the mounting clip may include a rib or a lug and the mounting clip receiving portion may define at least one channel or aperture, wherein the rib/lug may be detachably received within the channel/aperture.

In an embodiment of the invention, the mounting clip comprises a resiliently deformable body, wherein the body defines an arcuate central portion; at a first end of the arcuate central portion is defined a planar window engagement portion; and at a second end of the arcuate central portion is defined a planar support platform; and wherein the plane of the engagement portion is substantially orthogonal to the plane of the support platform.

A window typically includes a window frame which extends outwardly from the glazing panel. The arcuate central portion permits the mounting clip to extend beyond the window frame when the window engagement portion is disposed between a window bead/sealing gasket and a glazing panel. It also avoids light strike around the edge of the shutter assembly, as the window covering outer frame of the shutter assembly may be aligned with the window frame which surrounds the glazing panel.

The arcuate body suitably defines an interior cavity; the planar engagement portion extends inwards towards the interior cavity (e.g., parallel to a radial line which extends inwards from the first end of the arcuate central portion towards the axis of the arc); and the planar support platform extends outwards away from the interior cavity (e.g., parallel to a radial line extending away from the second end of the arcuate central portion). In this arrangement, the planar support platform may be arranged perpendicular to the glazing panel, where it may support a bottom rail, a top rail or one of the stiles of the window covering frame.

It will be appreciated that if more than one mounting clip is coupled to a window, each of the planar support platforms may be arranged perpendicular to the glazing panel. Thus, the planar support platform of a mounting clip coupled to a top window frame member may be parallel to and face an opposing planar support platform of a mounting clip coupled to a bottom window frame member. A similar parallel and facing arrangement is achieved in relation to planar support platforms of mounting clips coupled to opposite side frame members of the window frame.

In order to achieve an orthogonal arrangement of the support platform plane and the engagement portion plane, the arcuate central portion suitably defines an arc of 90°. In other words, radii which extend to the first and second ends of the arcuate central portion define between them an angle of 90°.

In a further embodiment of the invention, the support platform includes an outwardly extending locating lug or boss which is received within a corresponding aperture defined by the mounting clip receiving portion. In the context of the subject invention, the term “outwardly extending” refers to the locating lug or boss extending out of the plane of the support platform.

The locating lug/boss is suitably resiliently deformable, for example to form a snap fit coupling with the respective mounting clip receiving portion. Thus, the locating lug/boss may be carried on or include a resiliently deformable leg. The locating lug/boss may further include a sloping or ramped leading portion. Such a ramped leading edge may urge the locating lug/boss to deflect as it is displaced towards the respective mounting clip receiving portion. When the locating lug/boss is aligned with the respective mounting clip receiving portion, it may snap back to its rest configuration. The locating lug/boss may further include a stop surface which prevents or resists deflection when urged away from the respective mounting clip receiving portion.

It will be appreciated that the resiliently deformable body of the mounting clip may need to be deflected away from its rest configuration in order to form a detachable coupling with the window covering frame. Accordingly, the mounting clip body may be formed from a metal, for example, steel, such as spring steel.

In alternative embodiments, the mounting clip receiving portion may be defined by a body and the mounting clip receiving portion body may define or carry elements which define the channel. The channel is suitably defined between a pair of spaced apart channel-forming elements. The mounting clip receiving portion body may be coupled to the outer frame.

In such embodiments, the mounting clip may include one or more ribs.

A single rib and a single channel may result in a fixed distance being defined between the window covering frame and the window. However, it may be desired to vary the distance between the window covering frame and the window. Accordingly, in an embodiment of the invention, the mounting clip receiving portion body defines or carries spaced apart elements which define a plurality of spaced apart channels. Additionally or alternatively, the mounting clip may define a plurality of spaced apart ribs. Thus, the desired distance may be selected by locating the rib(s) in the desired channel(s).

Suitably, the rib(s) are defined towards one end of the mounting clip. Thus, the mounting clip may include a body having a first end portion and the rib or each rib is carried or defined by the first end portion of the body.

Similarly, the window engagement portion of the mounting clip may be located at an opposite end of the mounting clip body. Accordingly, the mounting clip body may include a second end portion and the second end portion carries the window engagement portion.

As noted above, it may be desired for the mounting clip to extend perpendicularly relative to the glazing panel of the window. Accordingly, the second end portion may include a substantially planar body and the window engagement portion may extend substantially perpendicularly from the planar body. It will be appreciated that the window engagement portion suitably lies adjacent to the glazing panel in use. Thus, the window engagement portion may be a planar tab. In such an embodiment, the mounting clip body may extend perpendicularly relative to the glazing panel.

In order to couple the window covering outer frame more securely to the window, more than one mounting clip may be provided. In such embodiments, the window covering outer frame may define a plurality of mounting clip receiving portions and each mounting clip receiving portion may have associated with it a respective mounting clip. For example, the top frame member, the bottom frame member and optionally the opposed side frame members of the outer frame may each define at least one respective mounting clip receiving portion.

According to a second aspect of the invention, there is provided a window comprising a window frame; a glazing panel carried within the window frame; a window bead which secures the glazing panel to the window frame; and a shutter assembly as defined anywhere herein in connection with the first aspect of the invention, wherein the window engagement portion of the mounting clip is located between the window bead and the glazing panel; and wherein the window covering outer frame is coupled to the mounting clip via a coupling defined between the mounting clip receiving portion and the mounting clip. For example, a coupling defined between the mounting clip receiving portion and a planar support platform of the mounting clip.

The shutter assembly suitably includes two or more mounting clips and the shutter assembly outer frame suitably include two or more corresponding mounting clip receiving portions. In such embodiments, a first mounting clip may be coupled to a top window frame member of the outer frame, and a second mounting clip may be coupled to a bottom window frame member of the outer frame.

In an embodiment of the second aspect of the invention, the shutter assembly includes two shutter doors, wherein each shutter door is hingedly coupled to a respective one of the side frame members of the outer frame. Thus, relatively large windows may be covered by two or more shutter doors hingedly coupled to the outer frame.

According to a third aspect of the invention, there is provided a method of coupling a shutter assembly to a window, wherein the shutter assembly is as defined anywhere herein in connection with the first aspect of the invention and the window includes a window frame, a glazing panel and a bead which secures the glazing panel within the window frame; wherein the method includes the steps of disposing the window engagement portion of a top mounting clip between a top portion of the glazing panel and window bead; disposing the window engagement portion of a bottom mounting clip between a bottom portion of the glazing panel and window bead; coupling one of the top mounting clip and bottom mounting clip to a corresponding top mounting clip receiving portion or bottom mounting clip receiving portion defined by the outer frame; and coupling the other of the top and bottom mounting clips to the corresponding top or bottom mounting clip receiving portion.

In an embodiment of the invention, the mounting clips include a resiliently deformable body and the method includes the step of deflecting the top mounting clip or bottom mounting clip before coupling the other of the top and bottom mounting clips to the corresponding top or bottom mounting clip receiving portion.

In a further embodiment, the shutter assembly includes two top mounting clips and two bottom mounting clips and the method includes the steps of disposing the window engagement portion of the two top mounting clips between a top portion of the glazing panel and window bead in a spaced apart relationship; disposing the window engagement portion of the two bottom mounting clips between a bottom portion of the glazing panel and window bead in a spaced apart relationship; coupling the two top mounting clips or the two bottom mounting clips to corresponding top mounting clip receiving portions or bottom mounting clip receiving portions defined by the outer frame; and coupling the other of the top and bottom mounting clips to the corresponding top or bottom mounting clip receiving portions.

In a further embodiment of the invention, the shutter assembly includes two top mounting clips, two bottom mounting clips and four side mounting clips; and the method includes the steps of disposing the window engagement portion of the two top mounting clips between a top portion of the glazing panel and window bead in a spaced apart relationship; disposing the window engagement portion of the two bottom mounting clips between a bottom portion of the glazing panel and window bead in a spaced apart relationship; disposing the window engagement portion of two of the side mounting clips between a first side portion of the glazing panel and window bead in a spaced apart relationship; disposing the window engagement portion of two of the side mounting clips between a second side portion of the glazing panel and window bead in a spaced apart relationship; coupling the two top mounting clips or the two bottom mounting clips to corresponding top mounting clip receiving portions or bottom mounting clip receiving portions defined by the outer frame; and coupling the other of the top and bottom mounting clips, and the side mounting clips to the corresponding top or bottom mounting clip, and side mounting clip receiving portions.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

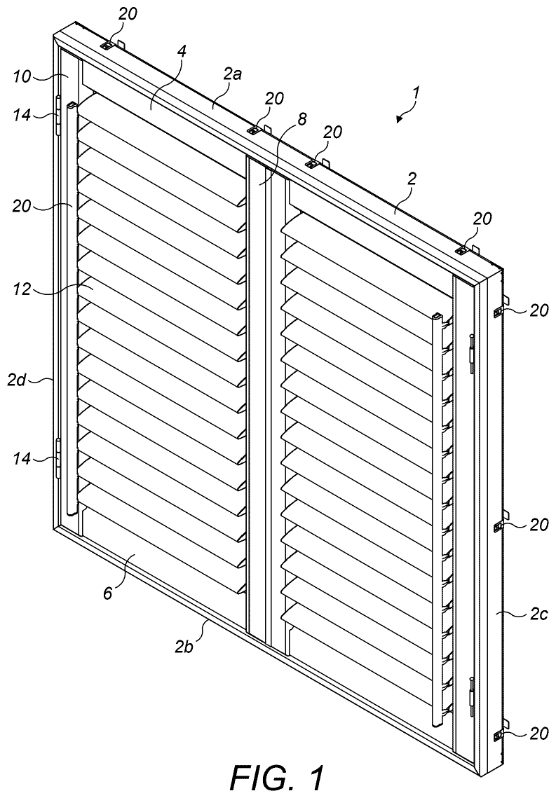

FIG. 1 shows perspective view of a shutter-style window covering according to the first aspect of the invention;

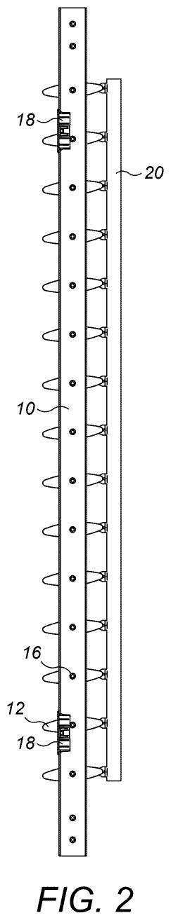

FIG. 2 shows a cross section through a shutter door of the shutter-style window covering shown in FIG. 1; and

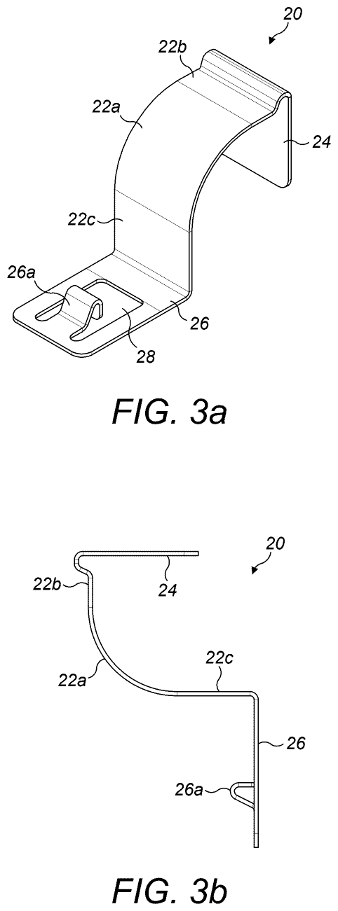

FIGS. 3a and 3b show a mounting clip which forms part of the shutter-style window covering shown in FIG. 1.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a shutter-style window covering 1, according to an embodiment of the invention according to its first aspect. The shutter-style window covering 1 comprises an outer frame 2 formed from a top frame member 2a, a bottom frame member 2b and a pair of opposed side frame members 2c, 2d.

Disposed with an aperture defined by the outer frame are a pair of shutter doors comprising a top rail 4, a bottom rail 6 and a pair of opposed stiles 8, 10. Each of the shutter doors is hingedly coupled to a respective one of the side frame members 2c, 2d via a pair of hinges 14 disposed between the side frame members 2c, 2d and the respective stile 8, 10.

A plurality of vanes 12 are rotatably coupled between the opposed stiles 8, 10. Such an arrangement is conventional in window shutters and many arrangements are known for rotatably coupling the vanes 12 between the stiles 8, 10. For example, each vane 12 may include projecting bosses at each end which are rotatably received within respective circular apertures defined by the stiles 8, 10. The axes of rotation of the vanes 12 are each horizontal in use.

The top frame member 2a, bottom frame member 2b, and the opposed side frame members 2c, 2d each define a plurality of apertures (not shown) which form respective mounting clip receiving portions, into which is received a locating lug 26a of a mounting clip 20, which is shown in more detail in FIGS. 3a and 3b.

FIG. 2 shows a side elevational view of a shutter door towards the stile 10. Each vane 12 is rotatably coupled to the stile 10 via a projecting boss 16 which is rotatably received within a circular aperture defined by the stile 10. Each of the vanes 12 are pivotally connected to a connecting rod 20. In this arrangement, if the connecting rod 20 is displaced upward or downward, all of the vanes 12 will all rotate accordingly. Similarly, if any one of the vanes 12 is rotated, the remainder of the vanes 12 will also rotate accordingly. Such an arrangement is common in window shutters and will be well known to the skilled person.

Hinge receiving rebates 18 are provided in the stile 10 to receive respective portions of the hinges 14.

FIGS. 3a and 3b show in more the detail the mounting clip 20. The mounting clip 20 includes an arcuate body portion 22a. At one end of the arcuate body portion 22a is a first extension portion 22b. At the opposite end of the arcuate body portion 22a is a second extension portion 22c

A planar window engagement portion 24 extends from the first extension portion 22b in the general direction of the axis of the arcuate portion 22a (i.e., into the cavity defined by the arcuate portion 22a and extension portions 22b, 22c).

A planar window covering engagement portion 26 extends from the second extension portion 22c in a direction which is away from the cavity defined by the arcuate portion 22a and extension portions 22b, 22c.

In this arrangement, the plane of the window engagement portion 24 is orthogonal to the plane of the window covering engagement portion 26.

The arcuate portion 22a and extension portions 22b, 22c permit the window covering engagement portion 26 to extend around the window frame of the window and to extend perpendicular to the glazing panel.

The window covering engagement portion 26 defines therein an aperture 28. A locating lug 26a extends from a part of the window covering engagement portion 26 into the aperture 28. The locating lug 26a also extends out of the plane of the window covering engagement portion 26.

The locating lug 26a is resiliently deformable relative to the window covering engagement portion 26. It includes a sloped or ramped leading edge portion and a rear stop surface which is substantially perpendicular to the window covering engagement portion 26.

The mounting clips are formed from spring steel, so that they are resiliently deformable.

In use, the four to mounting clips 20 are coupled to a top portion of a window by inserting the window engagement portion 24 of each clip between the glazing panel and a gasket disposed between the glazing panel and a top frame member of the window frame. The top mounting clips 20 are aligned with the apertures defined by the top frame member 2a.

The four bottom mounting clips 20 are then coupled to a bottom portion of the window by inserting the window engagement portion 24 of each clip between the glazing panel and a gasket disposed between the glazing panel and a bottom frame member of the window frame. The bottom mounting clips 20 are aligned with the apertures defined by the bottom frame member 2b

In this way, the window covering engagement portion 26 of each of the top and bottom mounting clips 20 extends perpendicularly away from the glazing panel. Furthermore, each of the top mounting clips 20 faces a corresponding bottom mounting clip 20.

A similar process is followed with respect to the side mounting clips 20. Three side mounting clips are coupled to each side portion of the window by inserting the window engagement portion 24 of each clip between the glazing panel and a gasket disposed between the glazing panel and a side frame member of the window frame.

In this way, the window covering engagement portion 26 of each of the side mounting clips 20 also extends perpendicularly away from the glazing panel. Furthermore, each of the first side mounting clips 20 faces a corresponding second side mounting clip 20.

The outer frame 2 is angled with respect to the window such that the top frame member 2a is aligned with the top mounting clips 20 and the bottom frame member 2b is spaced from the bottom mounting clips 20. In this orientation, the locating lugs 26a of the top mounting clips 20 are disposed within the respective locating apertures defined by the top frame member 2a.

The bottom of outer frame 2 is then pivoted towards the window. This causes the locating lugs 26a of the side mounting clips 20 and the bottom mounting clips 20 to be deflected outwards via interaction of the outer frame 2 with the respective ramped leading edges of the mounting clips 20. With the locating lugs 26a deflected, the frame 2 can be pivoted further until each of the locating lugs of the side and bottom mounting clips 20 are aligned with their respective apertures defined within the outer frame 2. Once aligned, the deflected located lugs 26a snap into their respective receiving apertures. With all of the locating lugs 26a forming a snap fit coupling with their respective receiving apertures, the outer frame 2 is coupled to the window via the mounting clips 20.

The stop surfaces of the locating lugs 26a prevents or resists the displacement of the window covering 1 away from the window

Furthermore, the bottom mounting clips 20 and to some extent, the side mounting clips 20 support the weight of the window covering 1.

It will be appreciated that a relatively simple mounting clip 20 is able to retain in place the window covering 1, which makes the shutter assembly of the invention relatively cheap to produce and easy to install.

1. A shutter assembly including a shutter-style window covering; and at least one mounting clip, wherein the shutter-style window covering includes an outer frame that defines an aperture; and at least one shutter door which includes a door frame and a plurality of vanes that are rotatably coupled to the door frame, wherein the vanes have a first orientation in which completely obscure an aperture defined by the door frame, and a second orientation in which they partially obscure the aperture; wherein the or each shutter door is hingedly coupled to the outer fame; wherein the outer frame defines at least one mounting clip receiving portion; wherein the or each mounting clip is detachably coupled to a respective one of the mounting clip receiving portion; and wherein the clip includes a window engagement portion via which the mounting clip may be detachably coupled to a window.

2. A shutter assembly according to claim 1, wherein the window covering outer frame comprises a top frame member, a bottom frame member and a pair of opposed side frame members.

3. A shutter assembly according to claim 1, wherein the or each shutter door frame comprises a top rail, a bottom rail and a pair of opposed stiles.

4. A shutter assembly according to claim 3, wherein the vanes are rotatably coupled to the opposed stiles.

5. A shutter assembly according to claim 1, wherein the vanes are connected together via a connecting element such that rotation of one of the vanes results in a corresponding rotation of all of the vanes, or movement of the connecting element results in the rotation of all of the vanes together.

6. A shutter assembly according to claim 1, wherein the mounting clip forms a friction fit or a snap fit within the mounting clip receiving portion.

7. A shutter assembly according to claim 6, wherein the mounting clip comprises a resiliently deformable body, wherein the body defines an arcuate central portion; at a first end of the arcuate central portion is defined a planar window bead engagement portion; and at a second end of the arcuate central portion is defined a planar support platform; and wherein the plane of the engagement portion is substantially orthogonal to the plane of the support platform.

8. A shutter assembly according to claim 7, wherein the arcuate body defines an interior cavity; the planar engagement portion extends inwards towards the interior cavity; and the planar support platform extends outwards away from the interior cavity.

9. A shutter assembly according to claim 7, wherein the arcuate central portion defines an arc of 90°.

10. A shutter assembly according to claim 7, wherein the support platform includes an outwardly extending locating lug which is received within a corresponding aperture defined by the mounting clip receiving portion.

11. A shutter assembly according to claim 7, wherein the resiliently deformable body is formed from steel.

12. A shutter assembly according to claim 1, wherein the window covering outer frame defines a plurality of mounting clip receiving portions and each mounting clip receiving portion has associated with it a respective mounting clip.

13. A shutter assembly according to claim 12, wherein the top frame member and the bottom frame member of the outer frame each define at least one respective mounting clip receiving portion.

14. A shutter assembly according to claim 2, wherein the shutter assembly includes two shutter doors, wherein each shutter door is hingedly coupled to a respective one of the side frame members.

15. A window comprising a window frame; a glazing panel carried within the window frame; a window bead which secures the glazing panel to the window frame; and a shutter assembly; wherein the shutter assembly includes a shutter-style window covering; and at least one mounting clip, wherein the shutter-style window covering includes an outer frame that defines an aperture; and at least one shutter door which includes a door frame and a plurality of vanes that are rotatably coupled to the door frame; wherein the vanes have a first orientation in which completely obscure an aperture defined by the door frame, and a second orientation in which they partially obscure the aperture; wherein the or each shutter door is hingedly coupled to the outer fame; wherein the outer frame defines at least one mounting clip receiving portion; wherein the or each mounting clip is detachably coupled to a respective one of the mounting clip receiving portion; and wherein the clip includes a window engagement portion via which the mounting clip may be detachably coupled to a window, wherein the window engagement portion of the mounting clip is located between the window bead and the glazing panel; and wherein the window covering frame is coupled to the mounting clip via a coupling defined between the or each mounting clip receiving portion and the respective mounting clip.
